(19) United States
(12) Patent Application Publication
(10) Pub. No.: US 2010/0200166 A1
(43) Pub. Date: Aug. 12, 2010

(54) LABEL PRINTER

(75) Inventor: Osamu Watanabe, Shizuoka (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/694,527

(22) Filed: Jan. 27, 2010

(30) Foreign Application Priority Data
Feb. 10, 2009 (JP) 2009-29035

(51) Int. Cl. B65C 9/46

(52) U.S. Cl. 156/384

(57) ABSTRACT

A label printer includes: a conveying section configured to convey a label sheet including a base sheet, on which a plurality of labels are stuck, in a forward direction and a backward direction; a printing section configured to print the labels in a process of conveyance of the label sheet; an aligning section configured to align one end face of the label sheet with a reference plane for printing in the printing section; a label peeling section configured to bend the label sheet, which finishes passing the printing section, to peel off the labels after the printing from the base sheet; a base sheet winding shaft configured to wind the base sheet from which the labels are peeled off by the label peeling section; an issue port configured to issue the labels after the printing peeled off by the label peeling section; and a label guide member provided in a position of the issue port close to a guide path for the base sheet extending from the label peeling section to the base sheet winding shaft and configured to have a vertex closest to a label peeling surface of the base sheet, from which the labels are peeled off, in a position extending from the center in the width direction of the labels after the printing issued from the issue port to the opposite side of the aligning section.

### CROSS-REFERENCE TO RELATED APPLICATION

This application claims the benefit of priority from Japanese Patent Application No. 2009-029035 filed on Feb. 10, 2009, the entire content of which is incorporated herein by reference.

### TECHNICAL FIELD

The present invention relates to a label printer.

### BACKGROUND

A label printer prints labels stuck on a long base sheet to line up in a longitudinal direction thereof. The labels after the printing are peeled off from the base sheet by a label peeling section. The label peeling section bends a guide path for sheets. The labels peeled off from the base sheet are issued from an issue port. The base sheet from which the labels are peeled off is wound around a base sheet winding shaft.

The labels to be printed by the label printer are stuck side by side with the other labels adjacent thereto in the longitudinal direction of the base sheet without any space (with very small spaces if any). A printing section configured to print the labels of such a sheet attached with labels (a base sheet stuck with labels) and the label peeling section configured to peel off the labels printed by the printing section from the base sheet are arranged close to each other. However, a space between the printing section and the label peeling section is larger than spaces among the labels on the base sheet.

Therefore, to peel off and issue a printed label, not only the label but also a label adjacent thereto to be printed next is conveyed farther than a printing position of the printing section (in a base sheet winding direction). If the printing section continues printing while the following label not printed yet passes the printing position because of the conveyance, a portion at the leading end of the following label cannot be printed.

Therefore, to prevent the portion that cannot be printed from being formed, so-call back-feed for conveying the sheet attached with labels in a backward direction is necessary when the following label is printed. The back-feed is performed by rotating, for example, a platen and the base sheet winding shaft in opposite directions.

When the sheet attached with labels is conveyed in a forward direction, an amount of sheet winding by the base sheet wining shaft needs to be set larger than an amount of sheet conveyance by the platen. Therefore, a back-feed amount in the base sheet winding shaft is larger in the back-feed. Consequently, slack occurs in the base sheet. When the slack occurs in the base sheet, skew occurs in the base sheet, causing deterioration in a print quality and, in the worst case, tearing of the base sheet.

Therefore, JP-A-10-016337 discloses the invention for preventing the base sheet from slacking during the back-feed of the sheet attached with labels by incorporating a one-way clutch in the base sheet winding shaft.

However, in this related art, the structure is complicated because the one-way clutch is incorporated in the base sheet winding shaft. Such complicated structure causes deterioration in assemblability, an increase in the number of components, an increase in component cost and manufacturing cost, and the like.

### SUMMARY

The present invention has been devised in view of the above and it is an object of the present invention to provide a label printer that does not cause skew in the base sheet in the printing section even when slack is caused by the back-feed and can surely prevent deterioration in print quality, tearing of the base sheet in the worst case, and the like due to the skew of the base sheet.

According to an aspect of the present invention, there is provided a label printer including: a conveying section configured to convey a label sheet including a base sheet, on which a plurality of labels are stuck, in a forward direction and a backward direction; a printing section configured to print the labels in a process of conveyance of the label sheet; an aligning section configured to align one end face of the label sheet with a reference plane for printing in the printing section; a label peeling section configured to bend the label sheet, which finishes passing the printing section, to peel off the labels after the printing from the base sheet; a base-sheet winding shaft configured to wind the base sheet from which the labels are peeled off by the label peeling section; an issue port configured to issue the labels after the printing peeled off by the label peeling section; and a label guide member provided in a position of the issue port close to a guide path for the base sheet extending from the label peeling section to the base sheet winding shaft and configured to have a vertex closest to a label peeling surface of the base sheet, from which the labels are peeled off, in a position extending from the center in the width direction of the labels after the printing issued from the issue port to the opposite side of the aligning section.

### DESCRIPTION OF THE DRAWINGS

FIG. 1 is a perspective view of the external appearance of a label printer according to an embodiment of the present invention;

FIG. 2 is a schematic sectional view of the label printer in a state in which a drawer unit is housed in a housing;

FIG. 3 is a perspective view of a state in which the drawer unit is drawn out from the housing;

FIG. 4 is an enlarged top view of the vicinity of a front panel in the state in which the drawer unit is drawn out from the housing;

FIG. 5 is a schematic sectional view of the label printer in a state in which a base sheet projects to an issue port side; and

FIG. 6 is an enlarged top view of the vicinity of the front panel in a state in which the drawer unit is drawn out from the housing.

### DETAILED DESCRIPTION

Exemplary embodiments of the present invention are explained in detail below with reference to the accompanying drawings. In an example explained below, the present invention is applied to a label printer configured to issue labels and receipts on which information related to commodities such as foods is printed. However, the present invention is not limited to this and can be applied to any apparatus as long as the apparatus prints various kinds of information on recording media such as sheets.

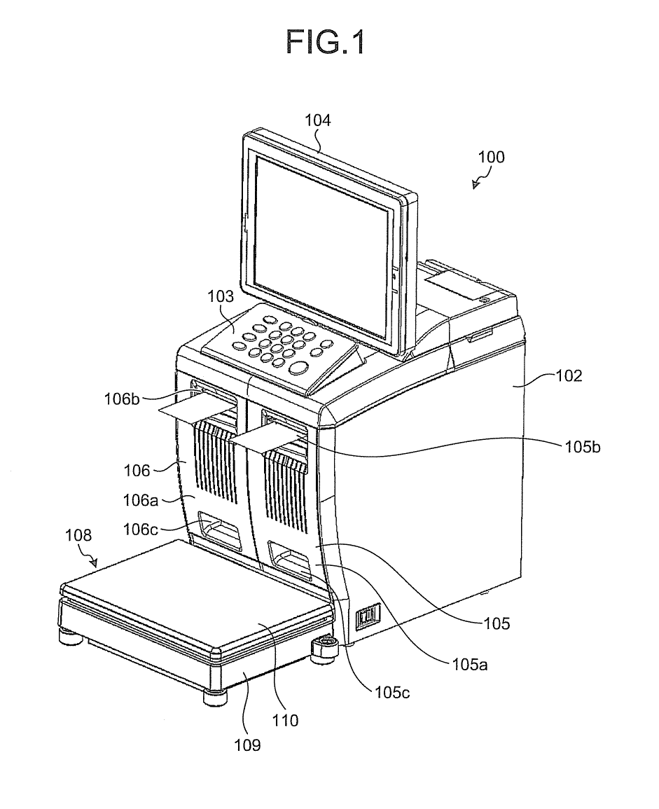

FIG. 1 is a perspective view of the external appearance of a label printer 100 according to an embodiment of the present invention. The label printer 100 includes a housing 102 having a substantially rectangular parallelepiped shape. The label printer 100 includes, on the upper surface of the housing 102, an operation panel 103 including various keys such as a ten key and a display 104 as a display unit having a liquid crystal display. The label printer 100 includes an opening on the front side of the housing 102. The label printer 100 houses, in the opening, two drawer units 105 and 106 side by side.

The drawer units 105 and 106 of the label printer 100 include front panels 105a and 106a in front thereof. The front panels 105a and 106a include issue ports 105b and 106b opened in upper parts thereof. The front panels 105a and 106a include gripping sections 105c and 106c in lower parts thereof. In the label printer 100, the drawer units 105 and 106 are supported by the housing 102 and drawn out or housed in the front direction. With such a configuration, an operator can draw out the drawer units 105 and 106 from the housing 102 gripping the gripping sections 105c and 106c.

In FIG. 1, an apparatus arranged adjacent to the front of the label printer 100 is a measuring apparatus 108. The measuring apparatus 108 includes a main body apparatus 109 having a flat shape and a measuring plate 110 attached to the upper surface of the main body apparatus 109. The main body apparatus 109 has a function of measuring the weight of an article placed on the measuring plate 110 and outputting measurement data of the article. The measuring apparatus 108 is electrically connected to the label printer 100. The measuring apparatus 108 outputs the measurement data, which is output from the main body apparatus 109, to the label printer 100.

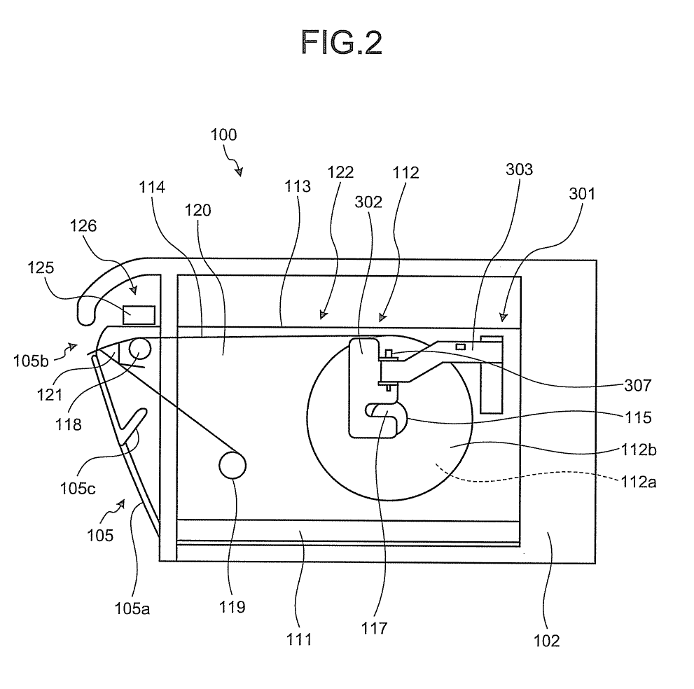

FIG. 2 is a schematic sectional view of the label printer 100 in a state in which the drawer unit 105 is housed in the housing 102. In FIG. 2, one drawer unit 105 located on the right side viewed from the front side of the label printer 100 of the two drawer units 105 and 106 is shown. The other drawer unit 106 located on the left side is configured to be symmetrical to the drawer unit 105 shown in FIG. 2. In the following explanation, only the drawer unit 105 located on the right side is explained. Explanation of the drawer unit 106 located on the left side is omitted.

In this embodiment, a label sheet 112 used for the drawer unit 105 is roll paper wound around in a roll shape. On the label sheet 112, a plurality of labels 113 are linearly stuck to a long base sheet 114. The label sheet 112 is wound round a paper pipe 115 in a roll shape. The labels 113 of the label sheet 112 are thermally sensitive labels that develop colors when heated.

The drawer unit 105 includes a sheet holding shaft 117, a platen 118, and a base sheet winding shaft 119. The sheet holding shaft 117 holds the label sheet 112 with the paper pipe 115 inserted therein. The base sheet winding shaft 119 winds the base sheet 114 of the label sheet 112. A sidewall 120 of the drawer unit 105 supports the sheet holding shaft 117, the platen 118, and the base sheet winding shaft 119 in a cantilever state. The sheet holding shaft 117 and the platen 118 and a label peeling section 121 and a base sheet winding shaft 119 explained later form a guide path 122 for the label sheet 112 extending from the sheet holding shaft 117 to the base sheet winding shaft 119 in the drawer unit 105.

The drawer unit 105 includes the label peeling section 121. The label peeling section 121 is located near a downstream side in a sheet conveying direction of the platen 118 in the guide path 122. The label peeling section 121 bends only the base sheet 114 of the label sheet 112 at an acute angle in a direction away from the labels 113. The drawer unit 105 peels off printed labels 113 from the base sheet 114 with the label peeling section 121 and issues the labels 113 from the issue port 105b. The drawer unit 105 bends the base sheet 114 from which the printed labels 113 are peeled off by the label peeling section 121 and guides the base sheet 114 to the base sheet winding shaft 119.

The sheet holding shaft 117 is horizontally supported in a cantilever state on the sidewall 120 of the drawer unit 105 as explained above and holds the label sheet 112 while being inserted in the paper pipe 115 of the label sheet 112. In other words, the sidewall 120 is an aligning section configured to align a first end face 112a, which is one end face of the label sheet 112, and function as a reference plane for printing. The sheet holding shaft 117 functions as a sheet holding section configured to rotatably hold the label sheet 112 wound in a roll shape with reference to an end face aligned by the sidewall 120 serving as the reference plane.

A pivoting member 302 as an interfering body urges a second end face 112b facing the opposite side (the front side in FIG. 2) of the sidewall 120 side (the depth side in FIG. 2) of the label sheet 112 held by the sheet holding shaft 117 with the paper pipe 115 inserted therein. Consequently, the label sheet 112 is pushed in the width direction of the label sheet 112 (an axis direction of the sheet holding shaft 117). On the other hand, the first end face 112a of the label sheet 112 comes into contact with the sidewall 120 serving as the reference surface for printing. In this way, the sidewall 120 and the pivoting member 302 nip the label sheet 112 to thereby regulate the movement of the roll paper that is about to move in the width direction when drawn out along the guide path 122.

The pivoting member 302 is pivotably attached to the distal end of an arm main section 303, which forms a part of a roll paper holding mechanism 301, via a pivoting member pivoting shaft 307. The arm main section 303 pivots and interferes with the second end face 112b of the label sheet 112, whereby the pivoting member 302 is rotated and displaced.

In the drawer unit 105, the platen 118 is arranged below the guide path 122. The platen 118 rotates with driving force received from a platen motor (not shown) via a gear train (not shown) and applies conveying force to the label sheet 112 on the guide path 122. The platen 118 draws out, with the conveying force, the label sheet 112 held by the sheet holding shaft 117 along the guide path 122. In this way, the platen 118, the platen motor, and the gear string function as a conveying section configured to draw out the label sheet 112 and convey the label sheet 112 along the guide path 122.

The base sheet winding shaft 119 rotates with driving force received from a winding motor (not shown) via a gear train (not shown) arrayed on the rear side of the sidewall 120. The base sheet winding shaft 119 winds, according to the rotation, only the base sheet 114 of the label sheet 112 that finishes passing the label peeling section 121. The drawer unit 105 includes the label peeling section 121 and the base sheet winding shaft 119 respectively in positions where the base sheet winding shaft 119 winds the base sheet 114 and bends the base sheet 114 at an acute angle in a portion where the label peeling section 121 is provided.

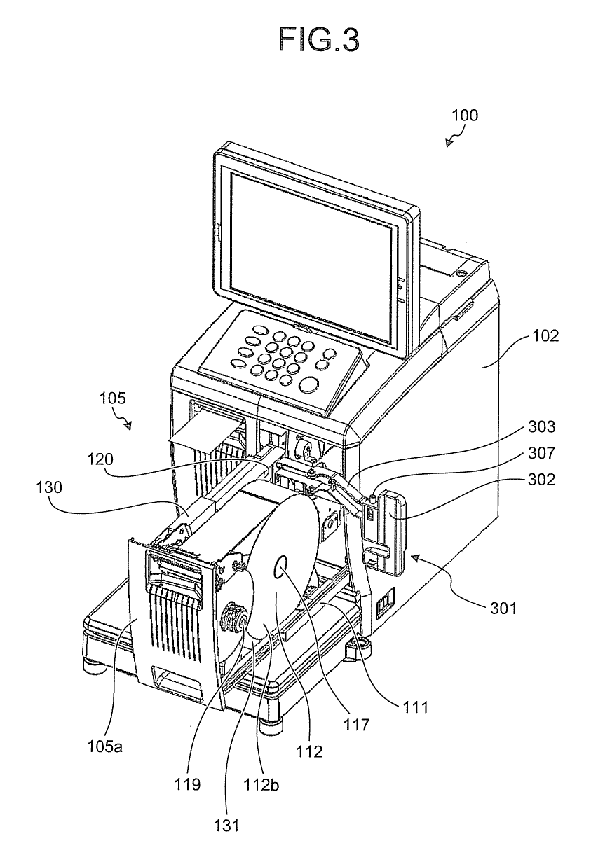

The drawer unit 105 includes a pair of rails 111 in a lower part on the inside of the housing 102. The rails 111 extend horizontally from an opening provided on the front side of the housing 102 to the depth side and slidably support the drawer unit 105. Therefore, the operator can slide, by gripping the gripping section 105c of the drawer unit 105 and drawing out the drawer unit 105, the drawer unit 105 in the front direction along the rails 111 and locate the drawer unit 105 in a drawn-out state to the outside of the housing 102 (see FIG. 3) from a housed state in the housing 102 (FIG. 2). The operator can also slide, by gripping the gripping section 105c, the drawer unit 105 in the depth direction along the rails 111 and locate the drawer unit 105 in the housed state shown in FIG. 2 from the drawn-out state shown in FIG. 3.

In the housing 102, a thermal head 125 is provided in an upper part in the inside. The thermal head 125 is a thermal print head of a line type. The housing 102 includes the thermal head 125 in a position opposed to the platen 118 in a state in which the drawer unit 105 is housed in the housing 102. The thermal head 125 configures a printing section 126 together with the platen 118. The platen 118 supports the label sheet 112 from below and specifies a gap between the label sheet 112 and the thermal head 125.

FIG. 3 is a perspective view of the state in which the drawer unit 105 is drawn out from the housing 102. The drawer unit 105 includes a side frame 130 having the sidewall 120 as described previously and a bottom frame 131 forming the bottom. The drawer unit 105 fixedly includes the side frame 130 on one side of the bottom frame 131. The other side is opened. Therefore, the drawer unit 105 assumes a substantially L-shape viewed from the front side. The sidewall 120 of the side frame 130 supports, in parallel to the bottom frame 131, the sheet holding shaft 117, the platen 118, the label peeling section 121, and the base sheet winding shaft 119 in a cantilever state. The drawer unit 105 slidably supports both side sections of the bottom frame 131 in the housing 102 via the rails 111.

In the label printer 100, the front panels 105a and 106a side is inclined to be higher than the depth side in housing the drawer units 105 and 106. Force is applied to the drawer units 105 and 106 by the gravity in a direction in which the drawer units 105 and 106 are housed in the housing 102. Therefore, the label printer 100 is prevented from tilting and toppling to the front panels 105a and 106a side when the drawer units 105 and 106 are unnecessarily drawn out.

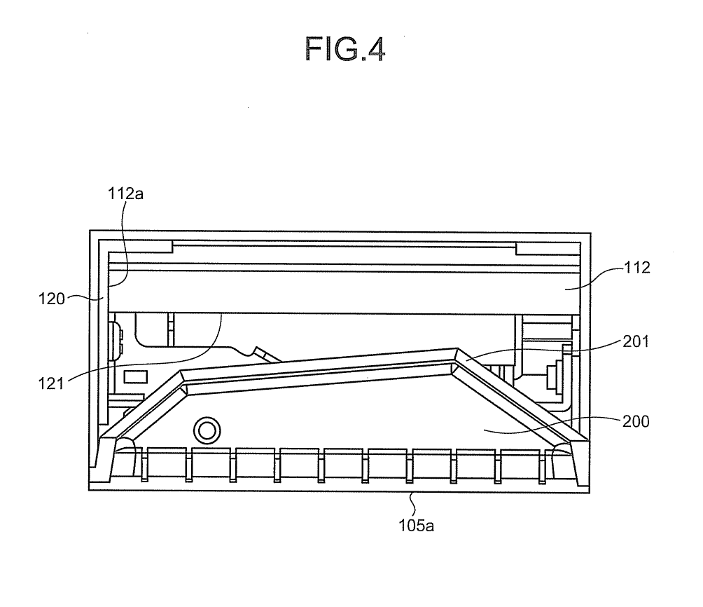

FIG. 4 is an enlarged top view of the vicinity of the front panel 105a in the state in which the drawer unit 105 is drawn out from the housing 102. As shown in FIG. 4, the drawer unit 105 includes a label guide member 200 formed of synthetic resin or the like near the label peeling section 121 in a position close to the guide path 122 for the base sheet 114 extending from the label peeling section 121 of the issue port 105b of the front panel 105a to the base sheet winding shaft 119. The label guide member 200 is formed in a sloped tabular shape inclining toward the sidewall 120 functioning as the reference plane for aligning the first end face 112a, which is one end face of the label sheet 112. More specifically, the label guide member 200 has a vertex 201 closest to the label peeling surface of the base sheet 114, from which the labels 113 are peeled off, in a position extending from the center in the width direction of the printed labels 113, which are conveyed through the guide path 122, peeled off from the base sheet 114 by the label peeling section 121, and issued from the issue port 105b, to the opposite side of the sidewall 120.

The label printer 100 executes printing operation when power is supplied from a commercial power supply and the units of the label printer 100 are controlled to be driven by a not-shown microcomputer incorporated in the housing 102.

In such a configuration, the label printer 100 guides and conveys the label sheet 112 along the guide path 122 according to the rotation driving of the platen 118. The label printer 100 prints a predetermined matter on the labels 113 stuck to the label sheet 112 with the thermal head 125 set in contact with the platen 118 via the guide path 122. At the same time, the label printer 100 transmits power from a not-shown driving source such as a motor to the base sheet winding shaft 119 and winds the base sheet 114 forming a part of the label sheet 112 around the base sheet winding shaft 119. When the base sheet 114 is wound, since the speed of winding of the base sheet 114 by the base sheet winding shaft 119 is set higher than the conveying speed for the label sheet 112 in the printing section 126 but not to cause a slip in a printing position, the label sheet 112 after printing is in a tensed state. Therefore, tension is applied to the label sheet 112 bent at an acute angle by the label peeling section 121 and the labels 113 after printing are peeled off from the label sheet 112. Therefore, the label printer 100 issues the peeled labels 113 from the issue port 105b.

If the next print instruction is received after one label 113 is issued from the issue port 105b, the label printer 100 drives to reversely rotate the platen 118 and the base sheet winding shaft 119 to thereby back-feed the label sheet 112. The label printer 100 operates in this way to thereby align the following label 113 in the printing position. When the following label 113 is aligned, since the speed of winding of the base sheet 114 by the base sheet winding shaft 119 is set higher than the conveying speed of the label sheet 112 in the printing section 126 but not to cause a slip in the printing position, slack conventionally inevitably occurs in the base sheet 114.

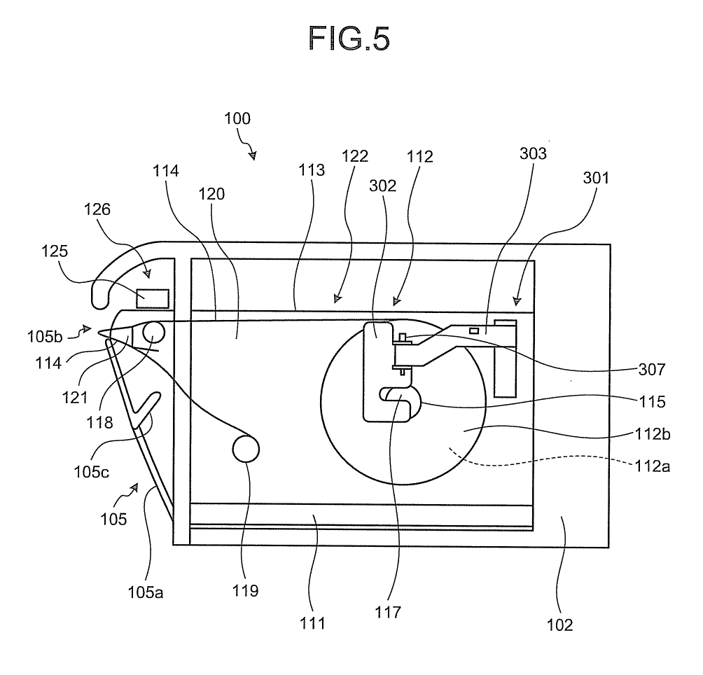

However, with the label printer 100, when slack is caused by reversely rotating the platen 118 and the base sheet winding shaft 119 to back-feed the label sheet 112, as shown in FIG. 5, the base sheet 114 in a portion bent at an acute angle by the label peeling section 121 projects to the issue port 105b side and comes into contact with the vertex 201 of the label guide member 200. The label printer 100 brings the slacked base sheet 114 into contact with the vertex 201 of the label guide member 200 to thereby guide the base sheet 114 along the shape of the label guide member 200 and move the base sheet 114 closer to the sidewall 120 side functioning as the reference plane.

As a result, the label printer 100 does not cause skew in the base sheet 114 in the printing section 126 even when slack is caused by the back-feed and can surely prevent deterioration in print quality, tearing of the base sheet in the worst case, and the like due to the skew of the base sheet.

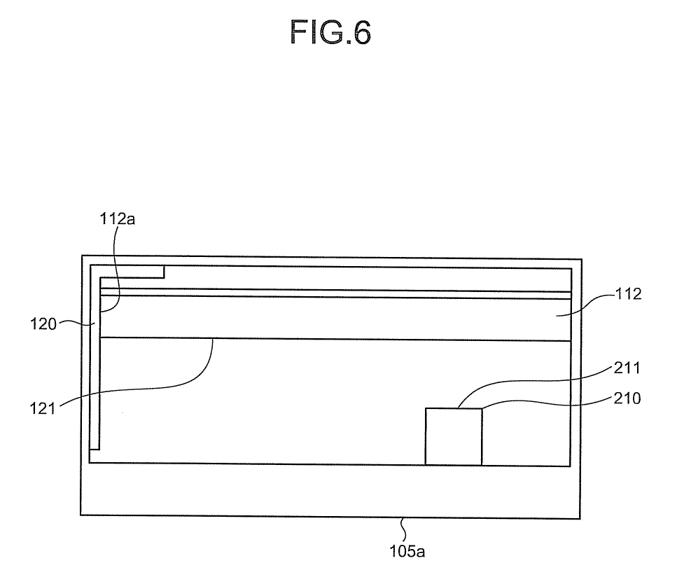

The shape of the label guide member 200 is not limited to the shape shown in FIG. 4 and various forms are conceivable. For example, as shown in FIG. 6, the label guide member may be a projected member 21 that is provided in a position close to the guide path 122 of the base sheet 114 extending from the label peeling section 121 of the issue port 105b of the front panel 105a to the base sheet winding shaft 119 and has a vertex 211 closest to the label peeling surface of the base sheet 114, from which the labels 113 are peeled off, in a position extending from the center in the width direction of the printed labels 113, which are issued from the issue port 105b, to the opposite side of the sidewall 120.

Further effects and modifications can be easily derived by those skilled in the art. Therefore, a wider aspect of the present invention is not limited by the specific details and the representative embodiment represented and described above. Therefore, various modifications are possible without departing from the spirit or the scope of the general concept of the invention defined by the appended claims and their equivalents.

What is claimed is:

1. A label printer comprising:
a conveying section configured to convey a label sheet including a base sheet, on which a plurality of labels are stuck, in a forward direction and a backward direction;
a printing section configured to print the labels in a process of conveyance of the label sheet;
an aligning section configured to align one end face of the label sheet with a reference plane for printing in the printing section;
a label peeling section configured to bend the label sheet, which finishes passing the printing section, to peel off the labels after the printing from the base sheet;
a base sheet winding shaft configured to wind the base sheet from which the labels are peeled off by the label peeling section;
an issue port configured to issue the labels after the printing peeled off by the label peeling section; and
a label guide member provided in a position of the issue port close to a guide path for the base sheet extending from the label peeling section to the base sheet winding shaft and configured to have a vertex closest to a label peeling surface of the base sheet, from which the labels are peeled off, in a position extending from a center in a width direction of the labels after the printing issued from the issue port to the opposite side of the aligning section.

2. The label printer according to claim 1, wherein the label guide member is formed in a sloped tabular shape inclining down to the aligning section side.

3. The label printer according to claim 1, wherein the label guide member is a projecting member having the vertex.

4. The label printer according to claim 1, wherein the label guide member is provided near the label peeling section.

5. The label printer according to claim 1, wherein the label guide member is formed of synthetic resin.

6. The label printer according to claim 1, wherein speed of winding of the base sheet by the base sheet winding shaft is set higher than conveying speed of the label sheet in the printing section.

7. The label printer according to claim 6, wherein the speed of winding of the base sheet by the base sheet winding shaft is set higher than the conveying speed of the label sheet in the printing section but not to cause a slip in a printing position.

8. The label printer according to claim 6, further comprising a unit configured to reversely rotate the conveying section and the base sheet winding shaft and back-feed the label sheet when a next print instruction is received after one piece of the label is issued from the issue port.

9. The label printer according to claim 1, wherein the label peeling section and the base sheet winding shaft are respectively located in positions where the base sheet winding shaft winds the base sheet and bends the base sheet at an acute angle in a portion where the label peeling section is provided.

10. The label printer according to claim 1, wherein the printing section includes a platen functioning as the conveying section and a thermal head provided in a position opposed to the platen.
